(19) United States
(12) Patent Application Publication
(10) Pub. No.: US 2011/0164558 A1
(43) Pub. Date: Jul. 7, 2011

(54) USING A PROXY TO IMPROVE A PACKET BASED WIRELESS NETWORK

(75) Inventors: Lawrence Chee, Richmond (CA); Balash Akbari, Vancouver (CA); Seyed M. Sharif-Ahmadi, Richmond (CA); Fay Arjomandi, Richmond (CA)

(73) Assignee: MOBIDIA, INC., Richmond (CA)

(21) Appl. No.: 12/824,115

(22) Filed: Jun. 25, 2010

Related U.S. Application Data
(63) Continuation-in-part of application No. 12/472,863, filed on May 27, 2009.
(60) Provisional application No. 61/220,875, filed on Jun. 26, 2009.

(51) Int. Cl. H04W 4/00

(52) U.S. Cl. 370/328

(57) ABSTRACT

This disclosure describes a system and method for optimizing the transport of payload data on a wireless telecommunications network. For downstream data flow to a mobile communication device client, an application proxy residing on a transmitting server terminates TCP data flows, extracts payload data and encapsulates the data into a UDP packet. A far host server residing on a receiving client device receives the UDP packet, extracts the payload and presents it to an application program on the client device as a TCP packet. For upstream data flow to a server, software running on the mobile communication device acts as the application proxy, extracting payload data from a TCP data flow and encapsulating the extracted data into a UDP packet. The server receiving the UDP packet will extract the payload and present it as a TCP packet.

### CROSS-REFERENCE TO RELATED APPLICATIONS

This application is a nonprovisional U.S. patent application of U.S. Provisional Patent Application No. 61/220,875, entitled “SYSTEM AND METHOD FOR IMPROVING PACKET BASED WIRELESS NETWORKS,” filed on Jun. 26, 2009; and a continuation-in-part of U.S. patent application Ser. No. 12/472,863, entitled “AGGREGATED SESSION MANAGEMENT METHOD AND SYSTEM, filed on May 27, 2009; both of which are incorporated in full herein.

### FIELD

This disclosure relates generally to wireless communications, and specifically, to enhancing reliability and reducing latency variation within wireless packet-based networks.

### BACKGROUND

A number of packet protocols have been developed and optimized for wired networks. For example, the congestion control used in the Transmission Control Protocol (“TCP”) has been adapted over time to achieve maximum throughput in fixed bandwidth networks and to work in a fair manner, even during heavy network congestion. However, as many packet based networks now include a wireless infrastructure, the congestion mechanisms in TCP may not be well suited to the different characteristics found in such a wireless infrastructure. These different characteristics include:
1. Longer latency/round trip time. The lower bandwidth of the wireless network introduces a considerable amount of latency for a packet. The longer latency is also caused by the nature of the shared network, in which each TCP session must wait for the appropriate scheduling before connecting to the network.
2. Variable bandwidth. The bandwidth for a mobile communication device is a function of many factors. For example, as a user of the mobile communication device moves, the distance to the antenna changes, which can negatively affect bandwidth. A moving user also has a higher chance of obstructing the signal path between the antenna and the mobile communication device. On the other hand, even if the user is stationary, other factors can still affect the signal between the user and the antenna, such as moving vehicles, other users joining and disconnecting from the shared network, proximity to other networks, and the associated power/bandwidth management of the radio frequency (“RF”).
3. Asymmetrical bandwidth. Downstream bandwidth from the network to the user equipment (“UE”) is typically higher than upstream bandwidth from the UE to the network. When downloading data, the speed of the download is governed by the speed of the returning acknowledgment (“ACK”) on the upstream. If the upstream is congested, the download bandwidth may not be fully consumed to its full potential.

For TCP, the longer latency and increased time for sending and receiving data (i.e., “round trip time”) impacts TCP's ability to quickly ascertain the available bandwidth even in a static bandwidth environment. In an environment with high variable bandwidth, it can be even more difficult for TCP to efficiently track the available bandwidth. Moreover, the asymmetrical bandwidth on the RAN may prevent TCP to utilize all downstream resources.

Variable bandwidth can also indirectly lead to dropped or lost packets, which is a very large concern for a wireless network. For example, if two or more TCP sessions become aware of available bandwidth in the wireless network, these TCP sessions may increase their data flow speed. This can result in an overloading of the buffers inside the network. Consequently, packets can be dropped off of the tail of the buffer. When there is an excess of packets, and packets are dropped, retransmission will occur, consuming resources that otherwise would transport new packets.

In addition, there are typically multiple, simultaneous TCP sessions from multiple sources destined to a single endpoint. For example, a user may be user surfing the web (which contains multiple sessions in itself) while downloading an email. Multiple sessions, all independent of each other, increases the difficulty in ascertaining the available bandwidth across all the sessions. This traffic phenomenon may be characterized as “bursty,” in that in the aggregate of all sessions, the instantaneous bandwidth can far exceed or be well below the overall capacity of the wireless network.

What is therefore needed is a way to take advantage of the ubiquitousness of TCP, but improve its efficiency to serve all types of network topologies, including wireless. It is desirable that any improvements in efficiency be transparent and applicable to the existing servers that are the source of the TCP sessions, as well as the mobile communication device clients that are the recipients of the TCP sessions.

### BRIEF DESCRIPTION OF THE FIGURES

FIG. 1 is a block diagram showing an embodiment of system architecture and data flow.

FIG. 2 is a flow diagram illustrating the steps of an embodiment.

FIG. 3 is a flow diagram illustrating the steps of an embodiment.

### DETAILED DESCRIPTION

Disclosed herein is a system and method for optimizing the flow of data in a packet-based wireless network. An embodiment of this disclosure teaches implementation of a proxy device at the entryway of a wireless network. The proxy device may perform the task of TCP handshaking with the originating source (known as a “TCP far host”) and destination (known as the “TCP client”). In this fashion, the delivery of TCP payload across a wireless network can be achieved without changing the existing infrastructure (far host or client) originally designed for wired networks. In this fashion, this disclosure may provide ways to leverage current infrastructure and user equipment (“UE”). As will be discussed further below, in an embodiment, a proxy may span the entire wireless network, with a server element in the core of the wireless network, and a client element embedded in a mobile communication device (i.e., a laptop or netbook capable of accessing a wireless network, a smartphone, a tablet computer accessing a wireless network, or any other device capable of accessing a wireless network). In an embodiment, the proxy eliminates TCP in the wireless network, extracts the data payloads found in each TCP session, converts the payloads into UDP, and transports the payloads across the wireless network in a reliable and holistic manner. In an embodiment, the proxy may be transparent to users.

It should be appreciated that an embodiment can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

In the context of this document, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

The disclosure of co-pending U.S. patent application Ser. No. 12/472,863, which is incorporated in full herein, includes discussion of an aggregated session management (“ASM”) system. A person having ordinary skill in the art will appreciate that the system that implements ASM as described in U.S. patent application Ser. No. 12/472,863 may also implement embodiments of this disclosure.

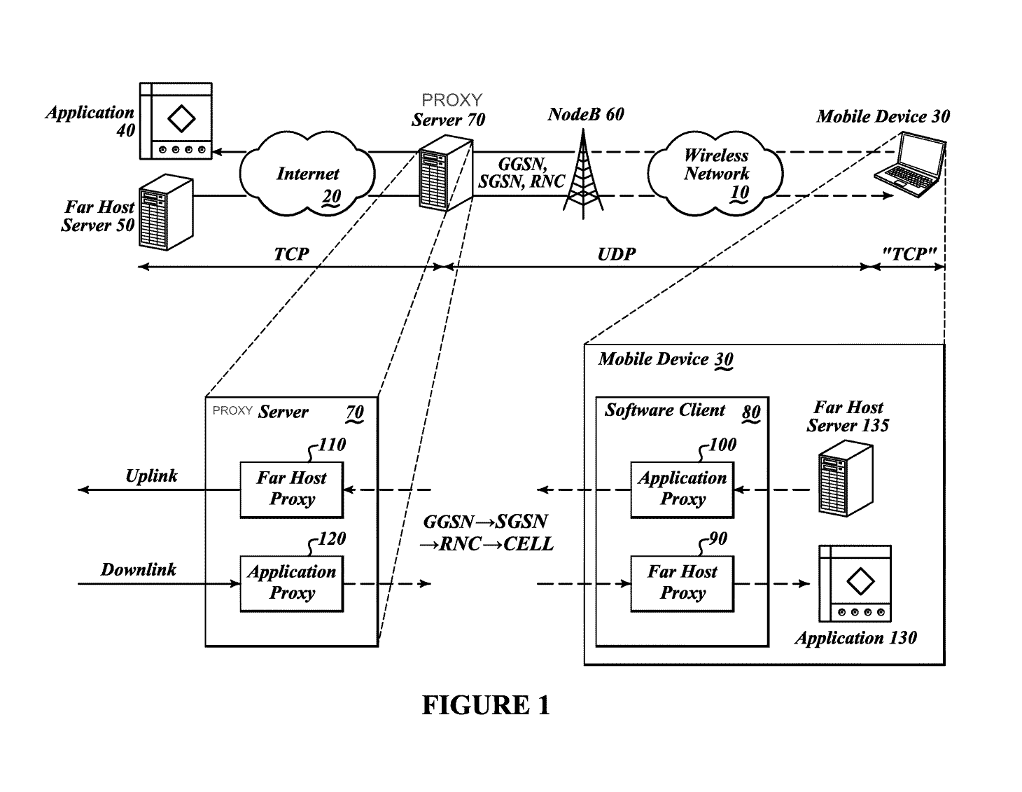

FIG. 1 is a block diagram illustrating an embodiment of a system in which a proxy server is located at the point of initial traffic entry from the Internet to the mobile network. As shown in FIG. 1, an embodiment of this disclosure may be implemented on a network, including wireless network 10 and a wired network, such as the Internet 20. The system embodiment of FIG. 1 may manage data flow between mobile communication device 30 and application 40 operating on far host server 50. Mobile communication device 30 may also be referred to herein as “client device 30” or “mobile device 30.”

As shown in FIG. 1, mobile device 30 may access application 40, first through wireless network 10 which may be linked to Node B 60, and then through Gateway General Serving Support Node (“GGSN”), Serving GPRS Support Node (“SGSN”), or Radio Network Controller (“RNC”) to Proxy Server 70, which in turn may access application 40 through the Internet 20. In an embodiment described further below, the protocol used for packets transmitted between proxy server 70 and mobile device 30 may be UDP, while TCP may be used for packets transmitted between proxy server 70 and far host server 50. One of ordinary skill in the art will appreciate that even though proxy server 70 is shown as a single server computer, proxy server 70 may in fact comprise one or more computers. The elements shown in FIG. 1 are not intended to limit this disclosure in any way.

In an embodiment, proxy server 70 may be located at the point of initial traffic entry from the Internet to the mobile network. In a UMTS or GSM based network, this may be at the Gi interface of GGSN. Mobile device 30 may include software client 80, which may include far host proxy 90 and application proxy 100. Proxy Server 70 may include its own far host proxy 110 and application proxy 120. In an embodiment, application proxies 100 and 120 may each terminate the TCP flows, extract the payload and encapsulate the payload into a UDP packet. In an embodiment, far host proxies 90 and 110 may each receive the UDP packet, extract the payload and present the payload to the application as a TCP packet.

Application proxy 120 within proxy server 70 may terminate TCP flows from far-host server 50 within the Internet 20. Within software client 80 on mobile device 30, application proxy 100 may terminate TCP flows from the application 130 running on mobile device 30. Mobile device 30 may act as far host server 135 in messages sent to application 40.

In an embodiment, far host proxy 110 within proxy server 70 may reverse the effects of application proxy 120 by converting packets to TCP. Within software client 80, however, the TCP packet may not be created, but the payload may be presented to application 130 as though it came from a TCP socket of the operating system operating on mobile device 30.

Proxy server 70 may use application proxy 120 for downstream data flow (i.e. to mobile device 30) and may use far host proxy 110 for upstream data flow (i.e. to far host server 50). Software client 80 on mobile device 30 may use application proxy 100 for upstream data flow and far host proxy 90 for downstream data flow. Combined, the four proxies, 90, 100, 110 and 120 are referred to herein as the Dynamic Multimedia Proxy (“DMP”). In this fashion, the DMP allows for flow control specifically designed for wireless networks, while “hiding” the behavior of the wireless network from the original TCP far host and TCP client flow control mechanisms.

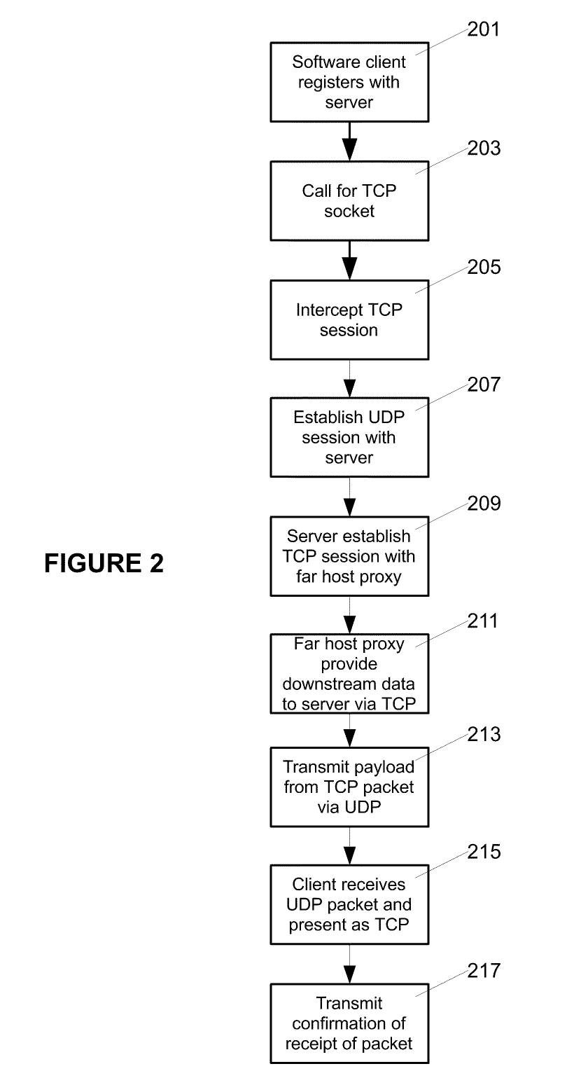

The following paragraphs describe various method embodiments for optimizing the downstream data flow, i.e., to mobile device 30. FIG. 2 is a flow diagram of this embodiment. In block 201, a software client 80 on mobile device 30 may seek out the server and register with the server. Various techniques for seeking out the server may include use of the server's IP address, or use of a DNS lookup to determine the server's address. Other techniques are also available, so long as the client is able to locate and register with the server. One of ordinary skill in the art will appreciate that registration facilitates communications between the client and the server.

In block 203 of FIG. 2, an application on the mobile device 30 may call for a TCP socket. One having ordinary skill in the art will appreciate that the application may include browser applications such as Mozilla Firefox®, Google® Chrome, Apple Safari®, Microsoft Internet Explorer®, and the like, and/or may include any email application such as Microsoft Outlook®, Apple® Mail, etc. In block 205 of FIG. 2, the client may intercept the TCP session initiation with the far host server (e.g. 3G USB radio). Instead, the client may establish a UDP session with the server (block 207 of FIG. 2). In block 209, the server may establish a TCP session with the far host acting as a proxy to the originating client application, i.e., the application that called for a TCP socket.

In block 211 of FIG. 2, the far host may provide downstream data via TCP to the server. In block 213 of FIG. 2, the server, acting as a proxy, may take the payload from the TCP packet and may transport the payload across the radio access network (“RAN”) via UDP. In block 213 of FIG. 2, an acknowledgement or ACK message may be transmitted to the far host to confirm receipt of the packet.

In block 215 of FIG. 2, the client may receive the UDP packet. The client may take the payload and present it to the application as though it came through the TCP socket. In block 217 of FIG. 2, the client may transmit an acknowledgement to the server confirming receipt of the packet.

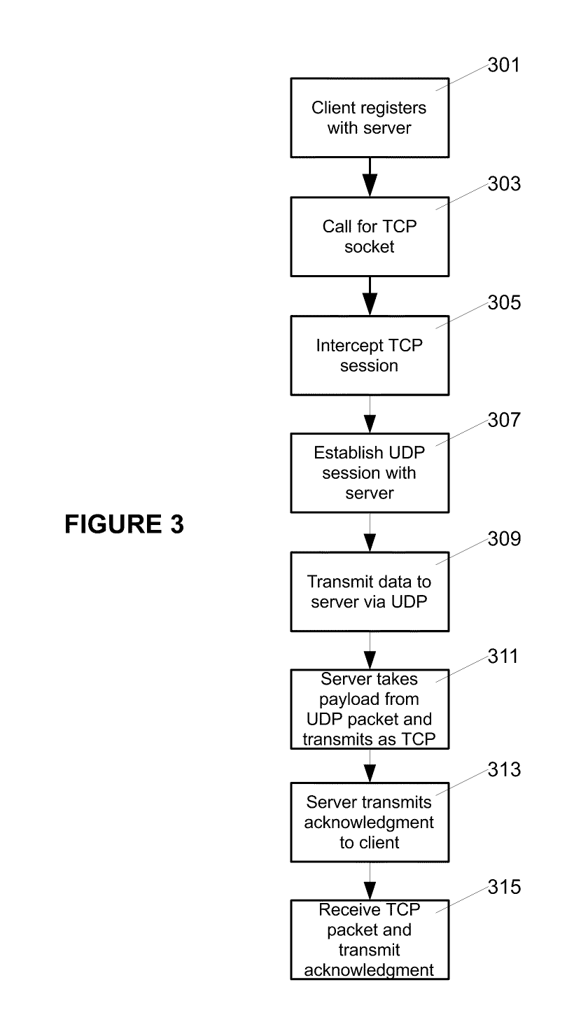

The following paragraphs detail an embodiment for optimizing the upstream data flow, i.e., to far host server 50. FIG. 3 is a flow diagram of this embodiment. In block 301, a client may seek out the server and register with the server. As mentioned above, various techniques for seeking out the server may include use of the server's IP address, or use of a DNS lookup to determine the server's address. In block 303 of FIG. 3, an application on the client may call for a TCP socket. In block 305 of FIG. 3, the client may intercept the TCP call before it heads out of the interface. The client may establish a UDP session with the server (block 307 of FIG. 3).

In block 309 of FIG. 3, the client may take the data provided by the application and transmit it to the server across the RAN via UDP. In block 311 of FIG. 3, the server may take the payload from the UDP packet, and may then transport the payload across the Internet as a TCP packet. In block 313 of FIG. 3, the server may transmit an acknowledgement to the client that confirming receipt of the packet.

In block 315 of FIG. 3, the far host may receipt the packet via TCP, and may transmit an acknowledgement to the server confirming that it received the packet. In this fashion, embodiments of this disclosure can utilize some of the handshaking mechanisms inherent in TCP, while also optimizing data flow by transferring packets using other protocols, such as UDP.

As the above-described examples demonstrate, data transmission that spans two distinct network segments may be optimized by having two distinct flow control mechanisms addressing each respective segment. A person of ordinary skill in the art will appreciate that there may be a one-to-one relationship between protocol sessions. For example, if there are ten TCP sessions for a given mobile device, there may be 10 UDP sessions initiated. Any class of service (“CoS”) markings (e.g. Differentiated Services Code Point or “DSCP”) assigned to the TCP session may be maintained (or modified if so desired) by the corresponding UDP session.

A person having ordinary skill in the art will appreciate that this disclosure my provide a mobile operator (i.e., a company that owns and/or operates the wireless networks) a way of lowering their capital expenditure (“CAPEX”) by extending the life and the utility of their existing network infrastructure, including transmission links, intermediary devices and other network components.

New equipment, such as next generation wireless networks with greater bandwidth than currently available equipment, may also benefit from this disclosure, which is agnostic to radio access technology. A person having ordinary skill in the art will appreciate that embodiments of this disclosure may be used in any environment where bandwidth variability/long latency exists in the transport medium.

In addition, a mobile operator may benefit from the opportunity to decrease its operational expenditure (“OPEX”). Current wireless networks may use backhaul fibres and copper wires linking the different network components (for Universal Mobile Telecommunications Systems (“UMTS”), these include Gateway General Packet Radio Service (“GRPS”), Serving Support Node (“GGSN”), Serving GPRS Support Node (“SGSN”), Radio Network Controller (“RNC”), and Node B) that may be physically distributed across a region that make up the wireless network. These interconnections may be over-provisioned to deal with the bursty traffic pattern exhibited by TCP, whereby such over-provisioning may be necessary to minimize packet loss. Embodiments of this disclosure may eliminate the need to over-provision network links. As a result, the mobile operator may reduce the speed of backhaul interconnections, which in turn may reduce its OPEX.

In addition, the mobile operator's customers who use the wireless network to access the Internet, may benefit by experiencing more consistent and, faster data transfers for download and uploads.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. One will appreciate that these steps are merely exemplary and are not meant to be limiting in any way. Other steps and functions may be contemplated without departing from this disclosure or the scope of an embodiment.

What is claimed is:

1. A method for optimizing data transmission to a mobile communication device comprising:
establishing, by a server computer, a first session using a first protocol for transmitting a data packet to the mobile communication device, the data packet having a data payload;
encapsulating, by an application proxy resident on the server computer, the data payload of the data packet using a second protocol; and,
establishing, by the application proxy, a second session using the second protocol for transmitting the encapsulated data payload to the mobile communication device such that the data payload is received by a far host proxy resident on the mobile communication device and accessed by the mobile communication device using the first protocol.

2. The method of claim 1, wherein the first protocol is TCP.

3. The method of claim 1, wherein the second protocol is UDP.

4. The method of claim 1, wherein a one to one ratio exists between first session and the second session.

5. A method for optimizing data transmission to a server comprising:
receiving, by a far host proxy resident on the server, a data packet having a data payload, the data packet encapsulated for transmission by an application proxy establishing a first session using a first protocol and received by the far host proxy establishing a second session using a second protocol.

6. The method of claim 5, wherein the first protocol is TCP.

7. The method of claim 5, wherein the second protocol is UDP.

8. The method of claim 5, wherein a one to one ratio exists between the first session and the second session.

9. A computer program product, comprising a computer usable medium having a computer readable program code embodied therein, the computer readable program code adapted to be executed to implement a method for optimizing data transmission to a mobile communication device, the method comprising:
establishing, by a server computer, a first session using a first protocol for transmitting a data packet to the mobile communication device, the data packet having a data payload;
encapsulating, by an application proxy resident on the server computer, the data payload of the data packet using a second protocol; and,
establishing, by the application proxy, a second session using the second protocol for transmitting the encapsulated data payload to the mobile communication device such that the data payload is received by a far host proxy resident on the mobile communication device and accessed by the mobile communication device using the first protocol.

10. The computer program product of claim 9, wherein the first protocol is TCP.

11. The computer program product of claim 9, wherein the second protocol is UDP.

12. The computer program product of claim 9, wherein a one to one ratio exists between the first session and the second session.

13. A computer program product, comprising a computer usable medium having a computer readable program code embodied therein, the computer readable program code adapted to be executed to implement a method for optimizing data transmission to a server, the method comprising:
receiving, by a far host proxy resident on the server, a data packet having a data payload, the data packet encapsulated for transmission by an application proxy establishing a first session using a first protocol and received by the far host proxy establishing a second session using a second protocol.

14. The computer program product of claim 13, wherein the first protocol is TCP.

15. The computer program product of claim 13, wherein the second protocol is UDP.

16. The computer program product of claim 13, wherein a one to one ratio exists between the first session and the second session.

17. A system for optimizing data transmission on a wireless network comprising:
a server having access to a mobile communication device over a wireless network;
an application proxy resident on the server, the application proxy configured to establish a first session using a first protocol; and,
a far host proxy resident on the server, the far host proxy configured to establish a second session using a second protocol.

18. The system of claim 17, wherein the application proxy is configured to extract payload data from a TCP data packet and convert the payload data using the UDP protocol.

19. The system of claim 17, wherein the far host proxy is configured to extract payload data from a UDP data packet and convert the payload data using the TCP protocol.

20. The system of claim 17, wherein the mobile communication device having an application proxy and a far host proxy.

21. The system of claim 20, wherein the application proxy is configured to extract payload data from a TCP data packet and convert the payload data using the UDP protocol.

22. The system of claim 20, wherein the far host proxy is configured to extract payload data from a UDP data packet and convert the payload data using the TCP protocol.

23. The system of claim 17, wherein a one to one ratio exists between the first session and the second session.
